(19) United States
(12) Patent Application Publication
(10) Pub. No.: US 2024/0075837 A1
(43) Pub. Date: Mar. 7, 2024

(54) Solar Shield

(71) Applicant: Marcus Henry Welles, Hampton, GA (US)

(72) Inventor: Marcus Henry Welles, Hampton, GA (US)

(21) Appl. No.: 17/901,930

(22) Filed: Sep. 2, 2022

(51) Int. Cl. B60L 53/51; B60J 1/20; B60L 53/18; H02S 10/40; H02S 40/22

(52) U.S. Cl. CPC B60L 53/51; B60J 1/2011; B60L 53/18; H02S 10/40; H02S 40/22

(57) ABSTRACT

Back Shield, is a sun shield protective design for your car form the sun's UV rays and adds privacy. The design gives the option for different material to be used. The binding tape that is sewn on three side of multiple material, offer multiple application outputs. The binding tape is sewn to encase the magnets between the material, holding the magnets in place. The magnets snaps to the steel in the vehicle, and hold the shields in place. The binding tape can be sewn on reflective vinyl, plastic mesh, and used to add thermal solar panel to the reflective material. The panels are custom fitted for each vehicle to ensure a proper fit. The shields fit to the interior of the car door window and stay in place until removed. The utility of the design offer the uses of different materials. Which allow for the different materials to be stacked on top of each other.

### TECHNICAL FIELD

The powering of electric vehicle with solar power. Solar panels, plus solar generator. and electric charging cable. In this instant the utility of the back shield design, the addition of solar panels. The solar panels are attached to the reflective material to be held up to the car windows to collect heat. With the binding tape and sewing.

### BACKGROUND OF THE INVENTION

Reflective material to protect your car from the sun and solar charging at the same.

The sun shade is a necessary part of vehicle comfort and protection. The utility of the Solar Shield design offer different, final products by the changing and addition of different materials. Solar Shield is made of a vinyl material consisting of three layer, vinyl, bubble, plastic. Which is excellent for blocking out the sun. The second application is the addition of solar panels, that will power electric cars. The third application is a plastic mesh material, that serves as a shade or window tint.

The technology of, powering a electric cars is a combination of components that plug into the electric car battery.

### BRIEF SUMMARY OF THE INVENTION

The following is intended to be a brief summary of the invention and is not intended to limit the scope of the invention.

The construction of the three layers is a key component to the utility of the design.

Layer one is the reflective vinyl that is the foundation to build on. Layer two are the magnets that snap to the steel in a car.

Layer three, the binding tape, is sewn along the edges to hold the binding tape in place on three sides of the reflective or plastic mesh material foundation.

The top and left and right sides of the binding tape hold the magnet in place to snap to the steel in a car.

While the horizontal stitching keeps the magnets from moving up or down the vertical stitching give them precise distance apart to ensure a strong hold.

The solar panel are for powering electric cars battery to fuel the car.

The solar panels in this example are layer two.

The solar panels are sewn on four sides to hold them in place.

The magnets hold the reflective material to the windows in the car, and hold the solar panels against the windows.

### BRIEF DESCRIPTION OF THE DRAWINGS

FIG. 1 shows the front driver side shield. The reflective material with magnets and binding tape sewn on three sides.

FIG. 2 shows the back driver side shield. The reflective material with magnets and binding tape sewn on three sides.

FIG. 3 shows the front passenger side shield. The reflective material with magnets and binding tape sewn on three sides.

FIG. 4 shows the front passenger side shield. The reflective material with magnets and binding tape sewn on three sides.

FIG. 5 shows the front passenger side mesh material. The mesh is a shade or tint like effect that keeps your car cool. It has the same construction with magnets and binding tape sewn on three sides. This mesh can stay up while you drive. It keeps the car cooler by blocking some of the sun light.

FIG. 6 is a car door with the mesh material snapped to the steel in the car. While the mesh is installed the reflective material can be placed right over it. The magnet snap to the steel, and the two material are stacked.

FIG. 7 shows the custom fit of each shied. The shield are made for the make and model of each car. This is and example of the reflective materials from the out side.

FIG. 8 show the reflective material form the inside of the car. The reflective material give 100% protection from the sun's UV ray's and adds privacy from some one looking into your car.

FIG. 9 show the reflective material with the addition of a solar panel. The panel sit at the bottom of the reflective material and is encase with the binding tape and sewing machine stitching on all four sides. The magnets snap the reflective material in place and hold the solar panel against the window to expose the panel to the sun.

FIG. 10 is the front driver side window, the interior showing the opening for the solar panel power out cable.

FIG. 11 show the passenger side rear window with a solar panel. The reflective material is snapped to the steel in the car and exposing the solar panel to the sun. While the reflective material keeps the car cool.

FIG. 12 show the interior view of the reflective shield, with the location of the solar panel located at the bottom of the shield, so the weight of the solar panel seats on the car.

FIG. 13 shows the back window of the reflective material with the solar panel. The panel when remove from the car folds into froths and fits into a carrying bag.

FIG. 14 shows the front window reflective shield. The front shield has two openings at the top to hook to the sun visors hooks that the sun visor hook to. This hold the reflective shields up, the side magnets snap to the steel in the car placing the reflective material and the solar panel against the front window, exposing the solar panel to the sun.

FIG. 15 shows the back of the shield, and the opening for the out power and the folding stitching to fold the shield.

FIG. 16 shows a perspective view of a car with the back window shield, the passenger windows front and rear window. The components to power the electric cars fuel. The components consist of six solar panels, 1 solar generator, and one electric vehicle charging cable.

FIG. 17 shows the plastic mesh material that is a foundation to build on. It serves as a shade or tint. It reduces the amount of sun coming in the car. And when the sun goes down, you can just pull it down.

FIG. 18 shows the back window with the optional support piece.

FIG. 19 shows the electric vehicle charging cable. 100 v.

FIG. 20 shows a solar generator with 100 v pure sine wave AC outlet.

FIG. 21 shows the construction of the design foundation. The reflective material is a three layer material. The top layer is a reflective vinyl, next is a layer of bubbles and a layer of white plastic. On top of the reflective material are the magnets. Next is the binding tape. The binding tape is sewn along the outer edge, then sewn along the inner edge while placing the magnets and sewing on the other three sides to place the magnets about four inches apart. The shield are sewn on three sides. The top and left and right side, while leaving the bottom clean.

FIG. 22. shows the back view of the solar generator with the three solar panels plugged in.

FIG. 23. shows a flow cart of the solar components.

### DETAILED DESCRIPTION

The inventor provides a unique sun shield, sun shade, and sun power, to the world. The new utility design can be changed from a reflective material to plastic mesh, to the addition of solar panels. The present invention is described in enabling detail in the following examples, which may represent more than one embodiment of the present invention.

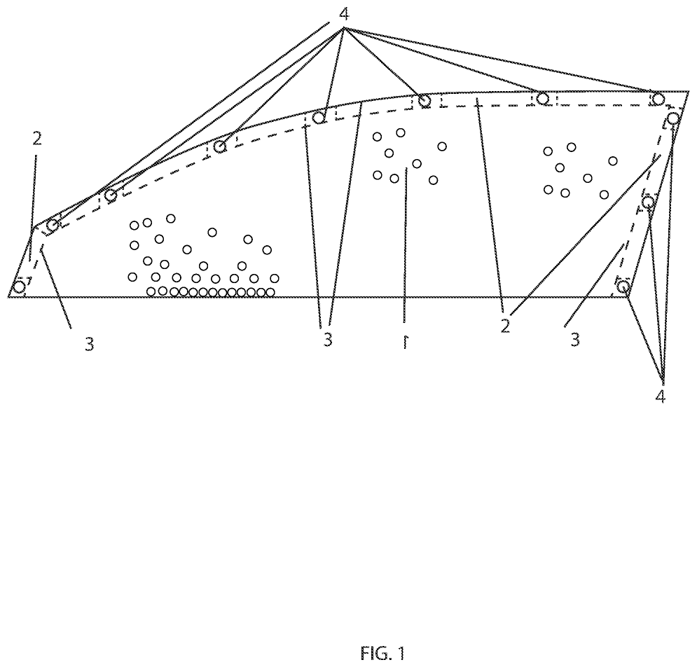

FIG. 1 is the front driver side reflective shield, that is made to the make and model of the car to ensure a custom fit. The shield snap to the steel in the car with magnets 4. The magnets are held in place with binding tape 2 that is stitch 3 to hold the magnets in place according to and embodiment of the present invention, in this example.

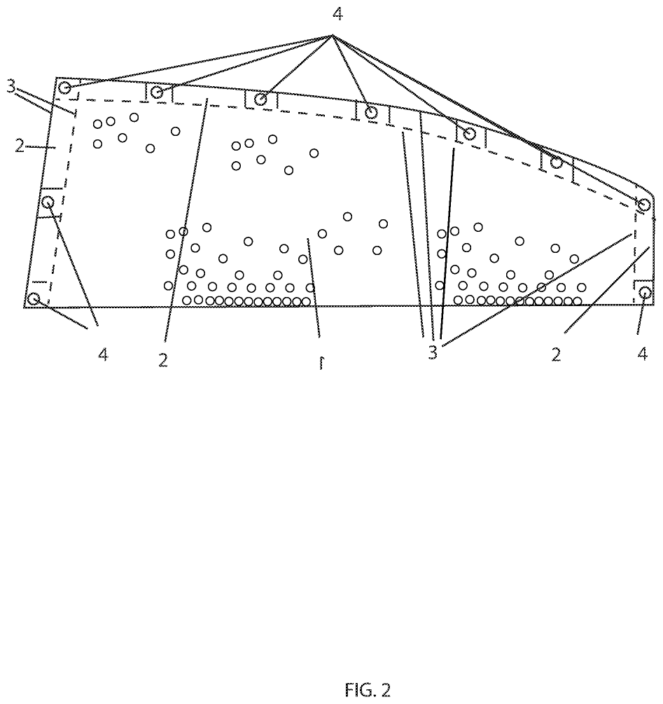

FIG. 2 is the back driver side window that has binding tape 2 on three sides. The binding tape 2 is sewn on the out side edge first, then the magnet 4 are placed about four inches apart, and sewn down.

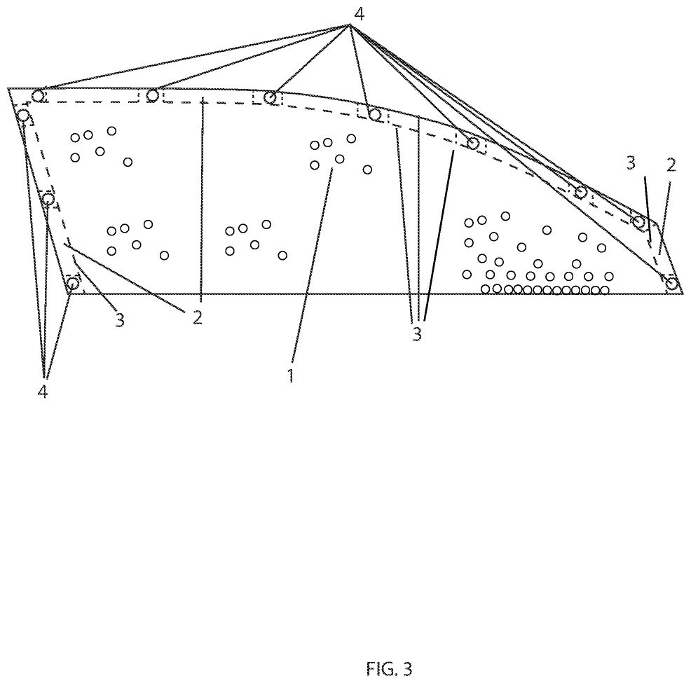

FIG. 3 is the front passenger side shield that snaps to the steel with magnets 4 and stay in place until removed. The binding tape 2 is stitched to surround the magnet 4 on four sides four inches apart.

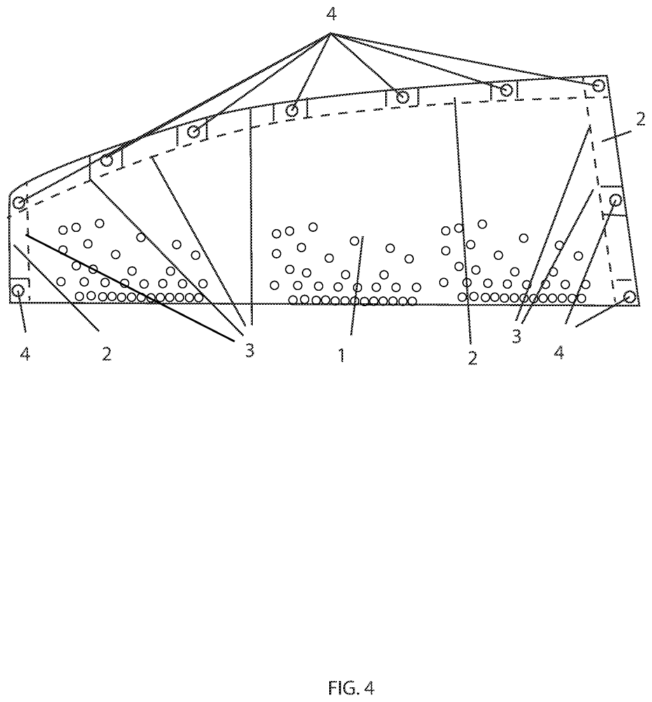

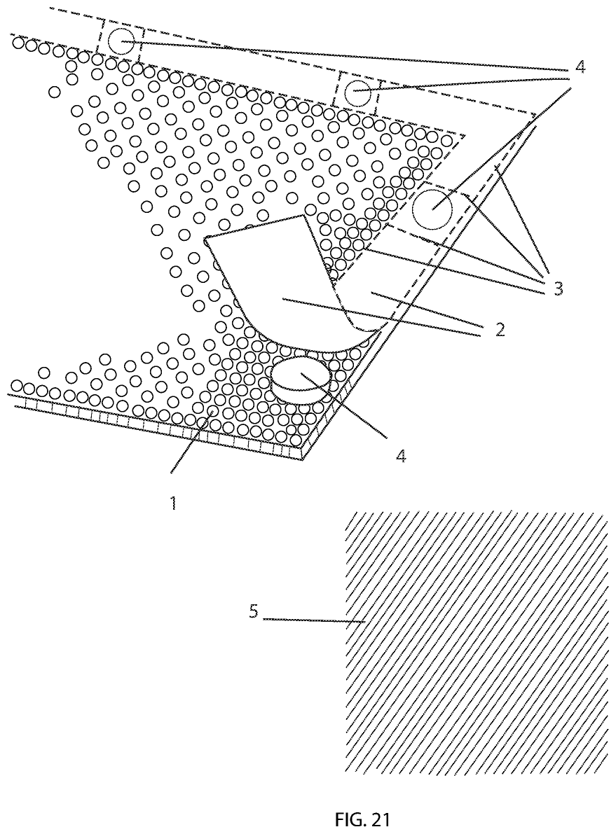

FIG. 4 is the back passenger side shield that snap to the steel in a car and offer 100% protection from the sun and adds privacy. FIG. 21 shows the actual construction of the reflective material 1, the binding tape 2, the sewing machine stitching 3, and the magnet 4 placement. The first four figures 1, 2, 3, 4, are a set of shields to block the sun's heat and prevent people from looking in to your car. They all have the same construction.

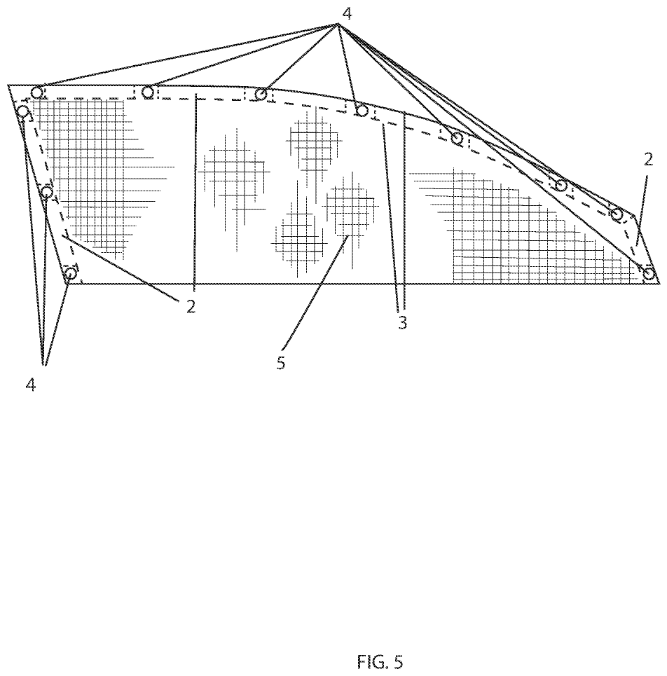

FIG. 5 is the plastic mesh 5 material that acts as a shade or tint. The plastic mesh 5 can be left up while you drive. It keeps the car cool and blocks some of the sun's rays. And when it gets dark you can just pull it down. FIG. 5 has the same construction as FIG. 21, with 1, 2, 3, 4, having the same characteristic as 21.

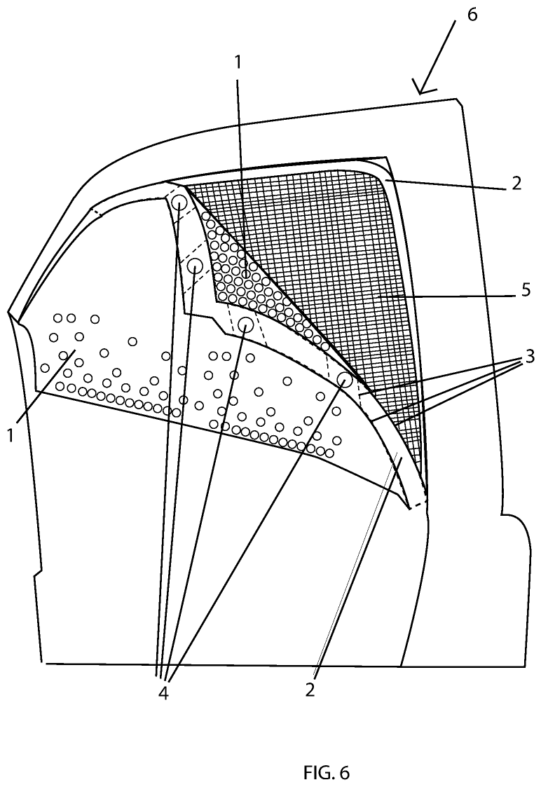

FIG. 6 show how the magnets 4 can stack the mesh plastic 5 and the reflective material 1 on the door at the same time. You don't have to take the plastic mesh 5 down to install the reflective material 1.

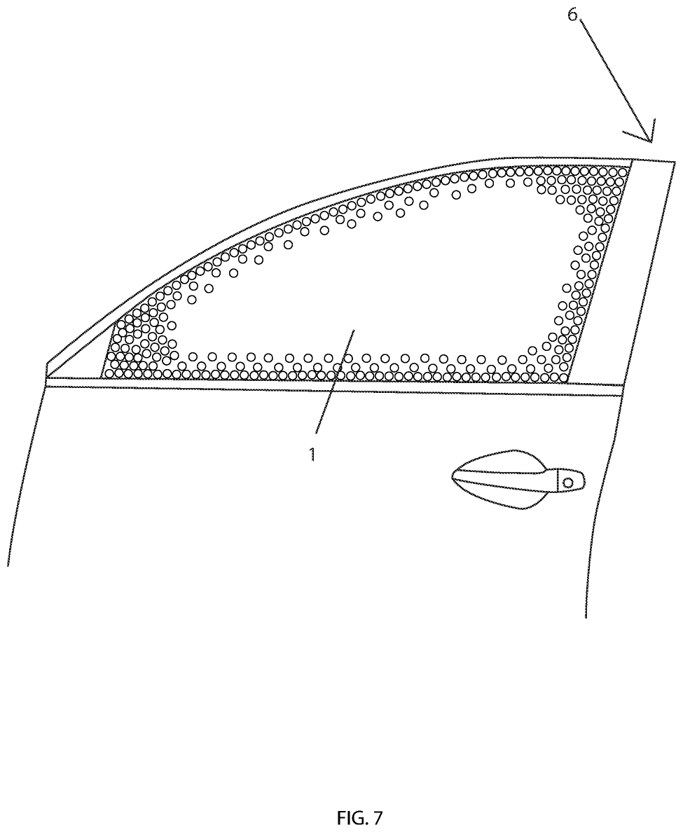

FIG. 7 is a car door 6 with the reflective material 1 showing the custom fit for the make and model of the car.

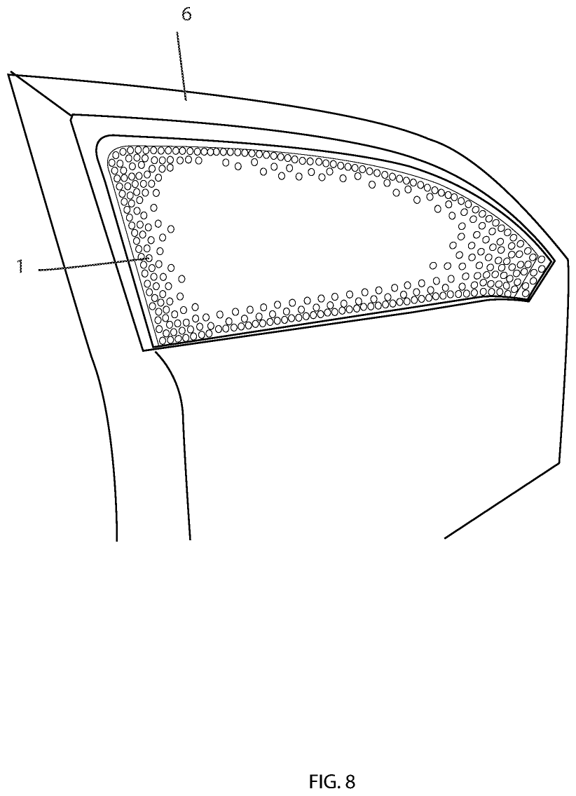

FIG. 8 is a car door 6 with the reflective material 1 with the shield installed offering privacy and protection from the sun heat.

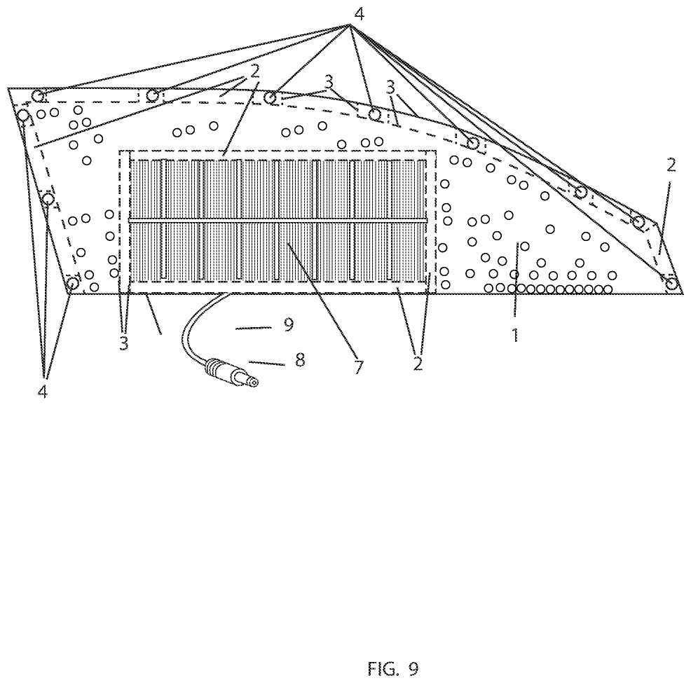

FIG. 9 is the front passenger side window with a solar panel 7 that is surrounded with binding tape 2 with sewing machine stitching 3. The solar panel sits at the bottom of the reflective material 1, so the weight of the panel is on the car. The solar panel 7 has a power out put cable 9, and a barrel plug 8, that goes to a solar generator 20. The other characteristic are describe in FIG. 21, magnets 4, stitching 3, binding tape 2, reflective material 1 according to another embodiment of the present invention in this example.

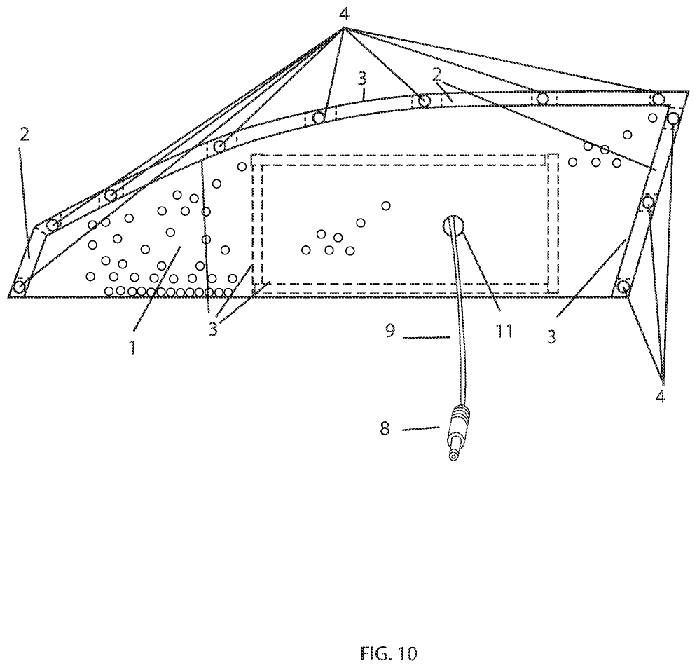

FIG. 10 is the back of FIG. 9 and the main differences is the opening 11 for the power out cable. The magnets 4 snap to the steel in the car and hold the solar panel against the window.

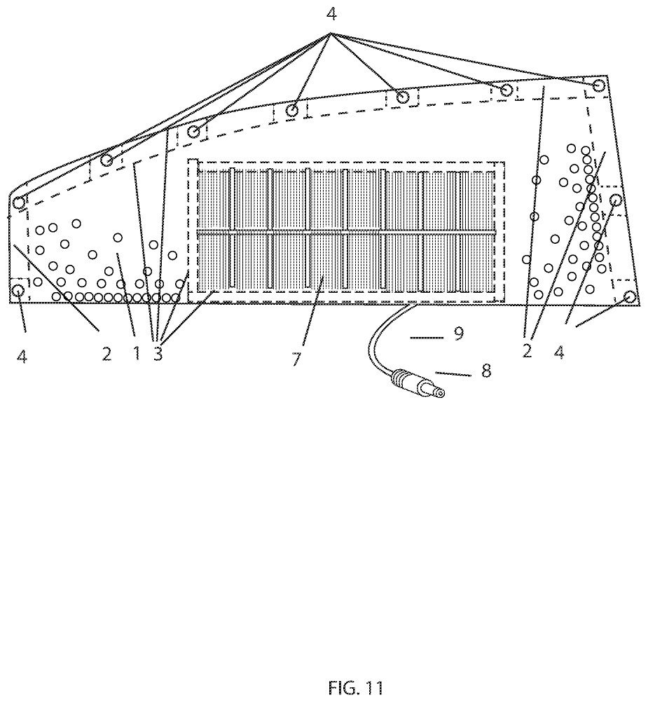

FIG. 11 is the back passenger side window with the solar panel 7 added. The panel has binding tape 2 and stitching 3 on four sides and sits at the bottom of the reflective material 1, to place the weight of the panel on the car. The barrel plug 8 leads to a solar generator 20. The rest of the characteristic are the same as FIG. 21 according to an embodiment of th present invention in this example.

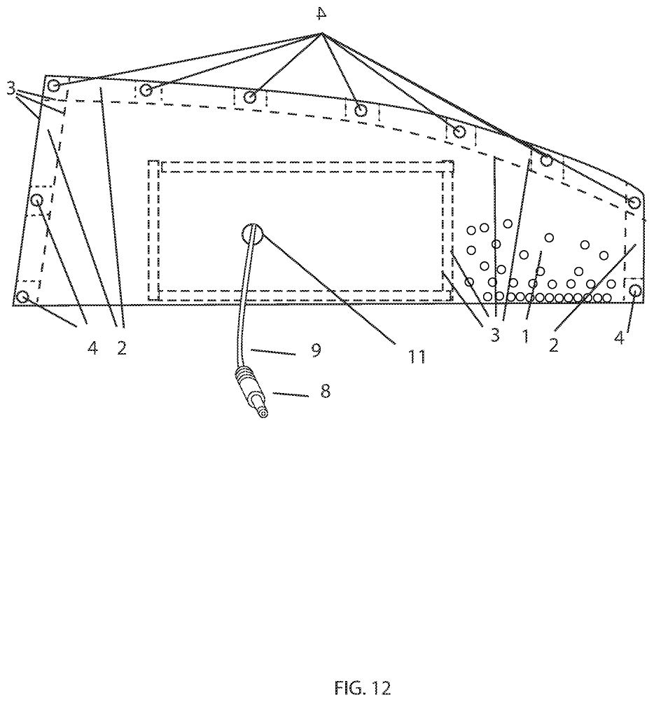

FIG. 12 is the back of FIG. 11, it uses the magnets 4 to snap to the steel in the car. Holding the solar panel 7 against the window to collect the sun heat. And at the same time protecting your car from the sun's UV rays, and adding privacy. The barrel plug 8 plugs into a solar generator 20, that powers the electric car main battery that fuels the car. The solar panel sits at the bottom of the reflective material 1, placing the weigh of the solar panel on the car.

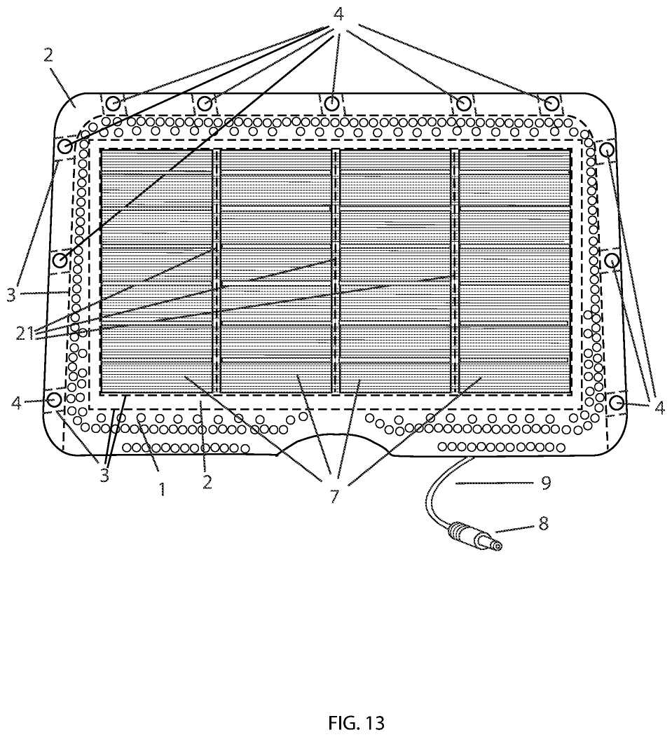

FIG. 13 is the back window reflective shield that snapped to the steel in the car with magnets 4, the binding tape 2 holds the magnets 4 in place. The solar panels 7 are attached with binding tape 2 on all four sides with sewing machine stitching 3. The magnets 4 hold the reflective material 1 against the window and holds the solar panel 7 in position to collect the sun's heat, that generate power to send to the solar generator 20. The reflective shield 13 can be removed from the window and folded with the fold stitching 21 according to an embodiment of th present invention in this example.

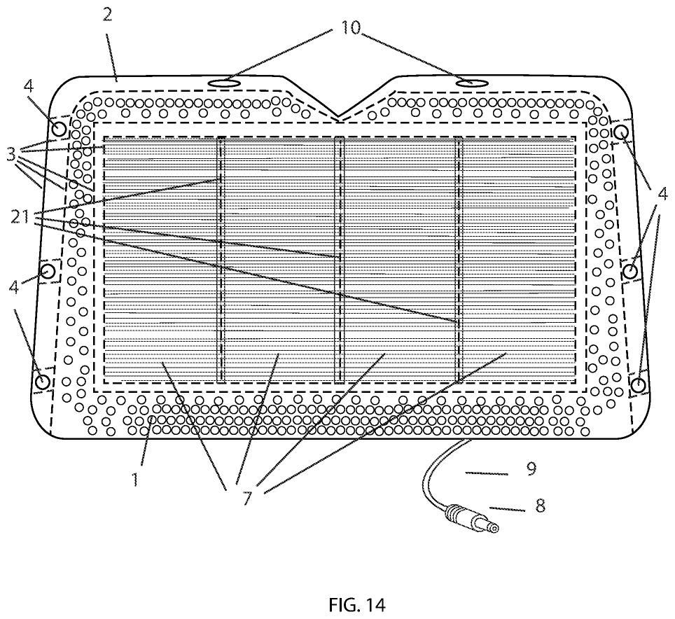

FIG. 14 is the front window reflective shield 14 only has magnets 4 on the sides, the top of the shield has opening 10 to hook to the sun visor hooks. The shield hooks to the sun visor hooks and the magnets 4 snap to the steel in the car, holding the solar panel 7 against the front wind shield, The solar panel 7 collect the heat from the sun, and generates energy that passed threw the cable 9 to the barrel plug 8, that powers the solar generator 20, that powers the car main battery that fuels the car. When taken down the reflective shield 14 can be folded by the folding stitching 21 according to an embodiment of the present invention in this example.

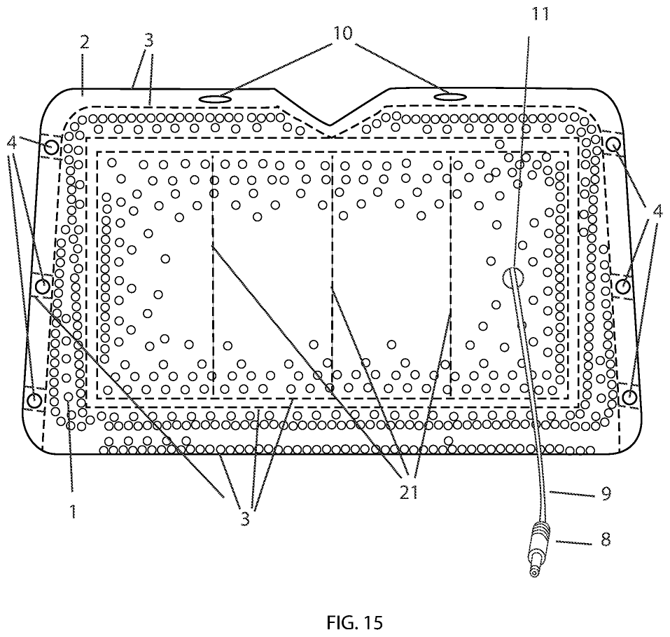

FIG. 15 is the back of 14 showing the opening 11 for the cable 9 that leads to the barrel plug 8, that plugs into the solar generator 20. While installed the shield blocks the sun and collect energy at the same time. Keeping your car from over heating and saving you money.

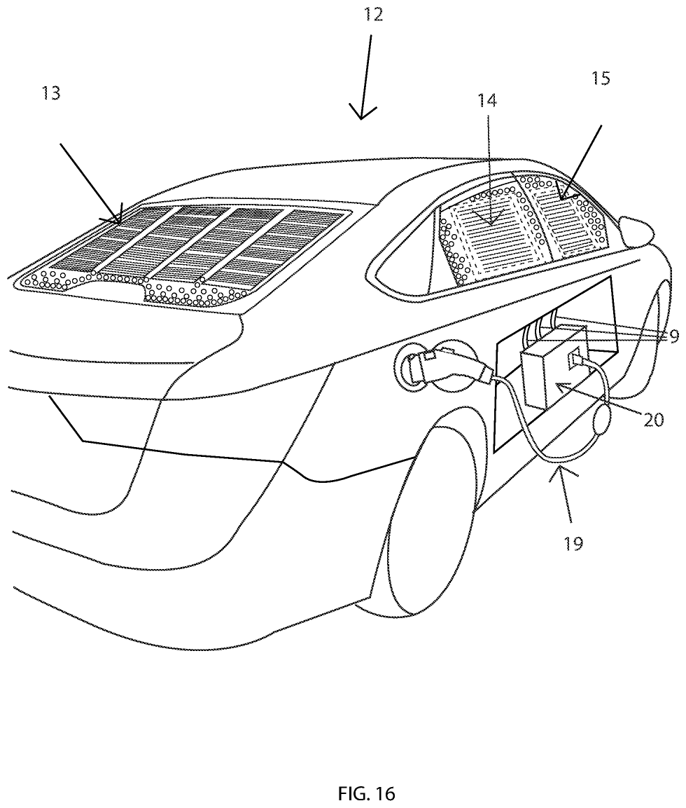

FIG. 16 is a perspective view of a car 12 showing the back window shield panel 13 snapped up to the window with magnets 4 collecting heat from the sun. The side shields 14, and 15 are installed in the car and held against the windows with magnets 4, collecting heat from the sun. At the same time blocking the sun from over heating the car. The sun heats the solar panels 13, 14, 15 and generates energy that pass threw the cables 9 into the solar generator 20. The electric car charging cable 19 plugs into the solar generator 20 and fuels the electric car battery with solar electricity by plunging into the car 12 according to an embodiment of the present invention in this example.

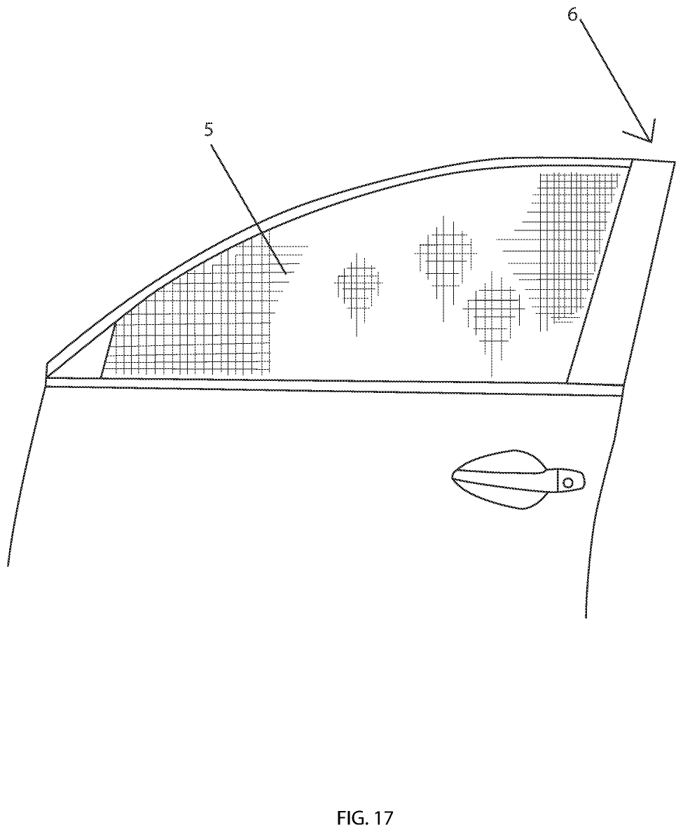

FIG. 17 show the plastic mesh material 5 installed on a car door 6. This plastic mesh material 5 filters the sun light and keeps your cool. You can leave it up while driving, and when the sun goes down, just pull it down.

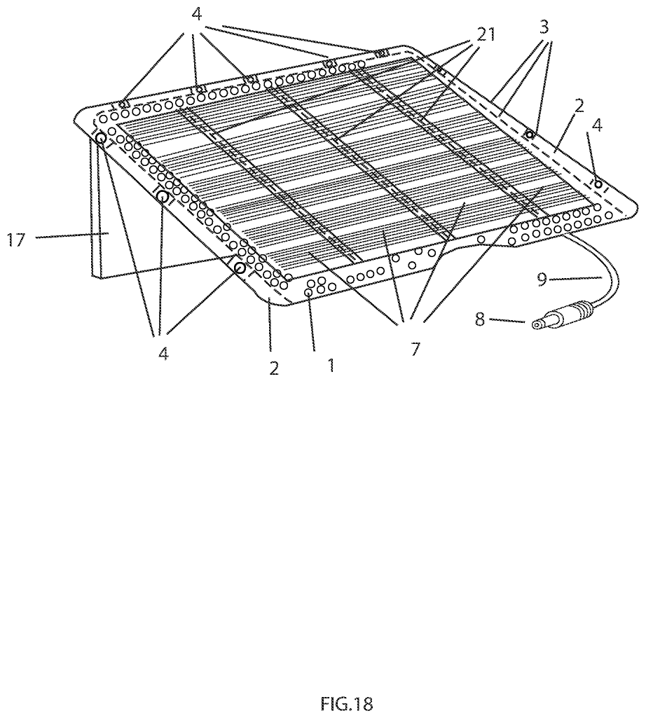

FIG. 18 shows the back window shield 13 with and optional support 17. When not installed in the car this panel sit up on a angle and collects the sun heat and power any thing that you can plug in. With the fold stitching 21 it can be easily folded up and place back in the car.

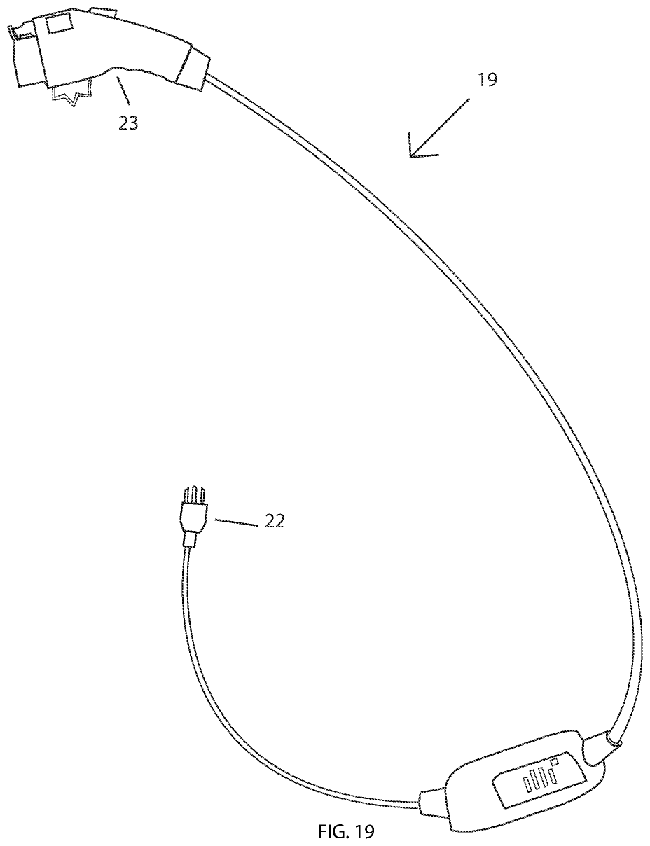

FIG. 19 shows the electric car charging cable 19. The plug 22 plugs into the generator 20 to receive the energy and 23 plugs in to the electric car to deliver the solar energy to the electric car battery fuel supply.

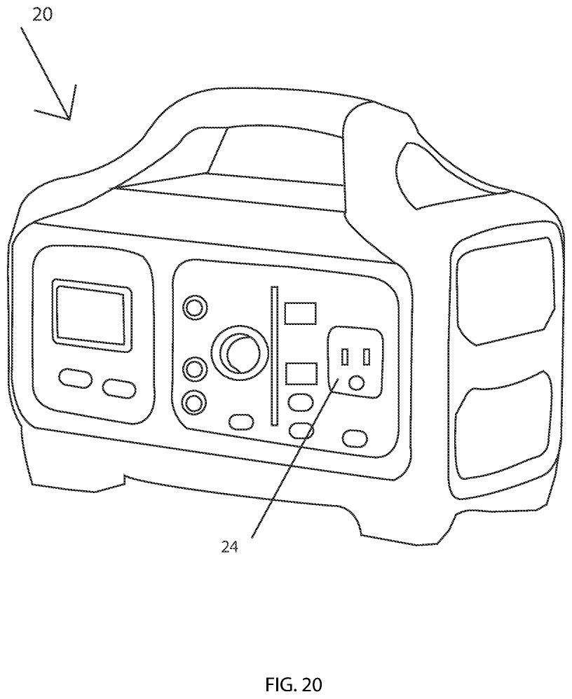

FIG. 20 shows the solar generator 20, that receives the solar energy from the solar panels 7. The electric vehicle charging cable 19 plugs into 24 of the solar generator. The charging cable 19 plugs into the electric car delivering the solar electricity to the electric car main battery that powers the car.

FIG. 21 shows the construction of the shield. The foundation reflective material 1 is a high quality three layer material 3/16″ thick. The first layer is a reflective vinyl, the middle layer is a bubble and the last layer is a white plastic. This material was design to block heat.

The second level are the magnets 4 that are placed on top, and left and right sides of the reflective material 1. The binding tape 2 is sewn along the out side edge first. Next, sewing the inside edge the magnets 4 are placed four inches apart and surrounded with vertical and horizontal stitching 3. With the custom fit and the magnets 4 on three sides of the reflective material 1 the shields will protect a car from the sun and add privacy. This is the same construction for the, plastic mesh 5 material. The mesh is a 8 oz. pvc that is durable and light weight.

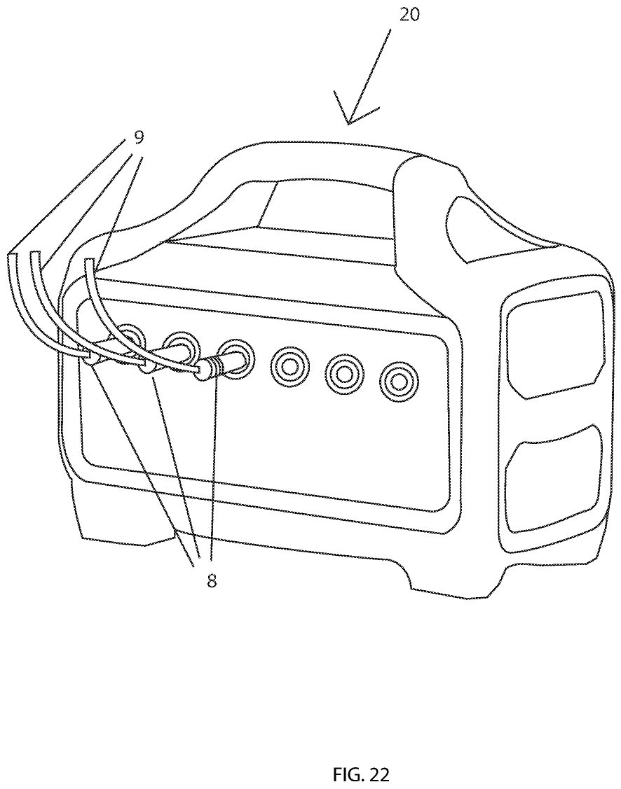

FIG. 22 shows the back view of the generator 20 with the three barrel plugs 8 from reflective shields 13, 14, and 15, with there cables.

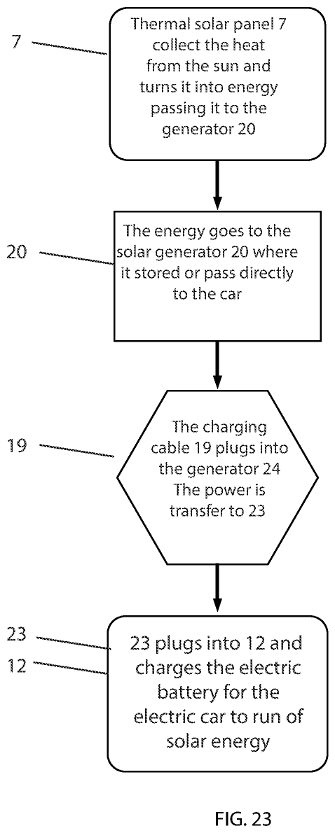

FIG. 23 is a flow chart showing the components of the solar construction.

It will be apparent to one with skill in the art that the solar shield invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. Solar Shield is multi level automotive protection and electric vehicle powering system.

2. The shields attach to the steel in your car and stay in place until removed.

3. They are made for the make and model of the car.

4. The solar powering system will change the world and lead to the electric car elevation.

5. The reflective material is fitted to the interior of the door for a perfect fit. Then magnetize to attached to the top and the left and right side of the car door interior, with binding tape and sewing.

6. Once the shield is installed with the reflective material I guarantee 100% protection from the sun.

7. I claim that a set of reflective shield will keep your car cool and add privacy.

8. The plastic mesh material can serve as a shade or tint.

9. The plastic mesh material can stay up while driving the car. The mesh material has the same construction as the reflective material.

10. The addition of solar panel to the reflective material are the next level of automotive power.

11. The reflective material with the solar panel have the same construction as the reflective material without the solar panel.

11. You can have multiple reflective shields with solar panels install at one time.

12. The magnetize reflective material holds the solar panel up to the inside of the car window.

13. While the solar panel are held against the window they collect the heat from the sun.

14. The solar panel transfer the energy to a solar generator.

15. The solar generator stores the energy for the electric car main battery that power the car fuel cell.

16. Once the solar generator is full from being charged by multiple solar panels, the energy passes directly to the electric car fuel cell, making your electric car, a solar electric car.

17. With the addition of a electric vehicle charging cable, being plunged into the solar generators 100 v outlet, and then plunging the universal connector to your electric car fuel system you will be solar power.

18. With the solar component you can have a solar power vehicle, solar panels, solar generator, electric vehicle charging cable.
